(19) United States
(12) Patent Application Publication
(10) Pub. No.: US 2008/0252196 A1
(43) Pub. Date: Oct. 16, 2008

(54) Active-Matrix Field Emission Display

(76) Inventors: Yoon Ho Song, Daejeon (KR); Jin Woo Jeong, Daegu (KR); Dae Jun Kim, Daejeon (KR); Jin Ho Lee, Daejeon (KR); Kwang Yong Kang, Daejeon (KR)

Correspondence Address: RABIN & Berdo, PC, 1101 14TH STREET, NW, SUITE 500, WASHINGTON, DC, 20005, US

(21) Appl. No.: 12/093,293

(22) PCT Filed: Jun. 28, 2006
(86) PCT No.: PCT/KR06/02511

§ 371 Date: May 9, 2008

(30) Foreign Application Priority Data
Nov. 10, 2005 (KR) 10-2005-0107370

(51) Int. Cl. H01J 1/62

(52) U.S. Cl. 313/496

(57) ABSTRACT

Provided is a field emission display (FED) in which field emission devices are applied to a flat panel display. The FED includes: a cathode plate including a substrate, first and second thin film transistors (TFTs) that are serially connected on the substrate, a field emitter disposed on a drain electrode of the second TFT, a gate insulating layer having a gate hole surrounding the field emitter, and field emission gate electrodes disposed on the gate insulating layer; and an anode plate including a substrate, and red, green, and blue phosphors disposed on the substrate, wherein the cathode plate and the anode plate are vacuum-packaged parallel and opposite to each other. According to the present invention, uniformity of the FED panel can be significantly improved, and an inherent source-drain leakage current of the TFT can be significantly reduced, so that a contrast ratio of the FED can be significantly enhanced.

### TECHNICAL FIELD

The present invention relates to a Field Emission Display (FED) in which a field emission device is applied to a flat panel display, and more particularly, to an active-matrix FED capable of enhancing pixel uniformity using a plurality of Thin Film Transistors (TFTs) that are serially connected.

### BACKGROUND ART

An FED is fabricated such that a cathode plate having a field emitter array and an anode plate having phosphor are vacuum-packaged leaving a uniform interval therebetween, e.g., 2 mm or less. Electrons emitted from a field emitter of the cathode plate impact on the phosphors of the anode plate to represent an image by cathodoluminescence. Recently, FEDs are undergoing intensive research and development, spurred on by the prospects of these flat panel displays replacing conventional cathode ray tubes (CRTs).

The field emitter, a main component of the FED, significantly varies in efficiency according to its structure, the emitter material and the emitter shape. Recently, the structure of the field emission device can be generally classified into a diode type composed of a cathode and an anode, and a triode type composed of a cathode, a gate, and an anode. In the triode type field emission device, the cathode or the field emitter emits electrons, the gate induces electrons to be emitted, and the anode receives the emitted electrons. The electrons are emitted by an electric field formed between the cathode and the gate in the triode type structure. Thus, the triode type structure can be driven at a low voltage and electron emission can be easily controlled compared to the diode type. Accordingly, the triode type FED is widely developed.

Examples of the field emitter material include metal, silicon, diamond, diamond like carbon, carbon nanotubes, carbon nanofibers, and the like. Carbon nanotubes and carbon nanofibers are widely employed as the emitter material because they are thin and sharp, and have superior stability.

FIG. 1 is a cross-sectional view of a carbon field emitter formed of carbon nanotubes or carbon nanofibers and a pixel of a conventional passive-matrix FED using the same, and FIG. 2 is a schematic view of a field emitter array of a cathode plate of the conventional passive-matrix FED shown in FIG. 1.

Referring to FIG. 1, the conventional passive-matrix FED includes a cathode plate 10a and an anode plate 11b. The cathode plate 10a has a glass substrate 11, a field emitter electrode 12 disposed on a portion of the glass substrate 11, a carbon field emitter 13 disposed on a portion of the field emitter electrode 12, a gate insulating layer 15 having a gate hole 14 surrounding the carbon field emitter 13, and a field emission gate electrode 16 disposed on a portion of the gate insulating layer 15, and the anode plate 10b has another glass substrate 17, and red, green, and blue phosphors 18 R,G, and B disposed on portions of the glass substrate 17. Here, the cathode plate 10a and the anode plate 10b are vacuum-packaged parallel to each other while facing each other.

The cathode plate 10a is composed of the field emitter electrodes 12 and the field emission gate electrodes 16 that cross each other in a matrix form as shown in FIG. 2, and regions formed by the intersection define pixels. Each pixel is composed of a plurality of carbon field emitters 13.

The conventional passive-matrix FED has a drive voltage for field emission not less than 50 V because the gate hole 14 surrounding the carbon field emitter 13 is large and the gate insulating layer 15 is thick, and the carbon field emitter 13 does not emit electrons within the pixel as well as between the pixels in a uniform manner. In addition, it is difficult to form the carbon field emitter 13 that is completely symmetric to the gate hole 14, so that the emitted electrons often flow into the field emission gate electrode 16 to cause a leakage current.

A technique for solving the above-described problem of the passive-matrix FED is disclosed in Korean Patent Publication Nos. 2004-0057866 published on Jul. 2, 2004 and 2005-0057712 published on Jun. 6, 2005. The disclosed technique will be briefly described below.

FIG. 3 is a cross-sectional view of a pixel of a conventional active-matrix FED, and FIG. 4 is a schematic diagram of a cathode plate of the conventional active-matrix FED.

Referring to FIG. 3, the conventional active-matrix FED includes a cathode plate 20a and an anode plate 20b. The cathode plate 20a has a glass substrate 21, a TFT 22 disposed on a portion of the glass substrate 21, a carbon field emitter 23 disposed on a portion of a drain electrode of the TFT 22, a gate insulating layer 25 having a gate hole 24 surrounding the carbon field emitter 23, and a field emission gate electrode 26 disposed on a portion of the gate insulating layer 25, and the anode plate 20b has another glass substrate 27, and red, green, and blue phosphors 28 R, G, and B disposed on portions of the glass substrate 27. Here, the cathode plate 20a and the anode plate 20b are vacuum-packaged parallel to each other while facing each other.

The cathode plate 20a of the FED has the carbon field emitter 23 and the TFT serially connected to the emitter in each pixel disposed in a matrix form as shown in FIG. 4. The carbon field emitter 23 of each pixel corresponds to one common field emission gate electrode 26. Accordingly, the conventional active-matrix FED applies a voltage to the field emission gate electrode 26 to induce electrons to be emitted from the carbon field emitter 23 while applying a high voltage to the anode plate 20b to accelerate the emitted electrons to represent an image. In this case, scan and data signals of the display are addressed to the TFT.

The conventional active-matrix FED can reduce a drive voltage for field emission to a drive voltage of the TFT and also significantly enhance uniformity between pixels compared to the passive-matrix FED.

However, the conventional active-matrix FED has one TFT to control a current of the field emitter per each pixel so that the uniformity within the pixel is still poor, and the field emission current cannot be accurately controlled due to source-drain leakage current of the TFT so that a contrast ratio of the display is degraded. In particular, when a voltage required for field emission is high, a high voltage is induced at the drain of the TFT, so that the source-drain leakage current may be significantly higher.

### DISCLOSURE OF INVENTION

### Technical Problem

Therefore the present invention provides an active-matrix FED capable of solving problems of the conventional active-matrix FED.

The present invention is directed to an active-matrix FED capable of significantly improving uniformity using first and second TFTs that are connected in series to each other within each pixel and a field emitter disposed on a portion of a drain of the second TFT.

The present invention is also directed to an active-matrix FED capable of significantly reducing a source-drain leakage current of a TFT as well as improving uniformity using a high voltage TFT as a TFT connected to a field emitter among a plurality of TFTs that are connected in series to each other within each pixel.

The present invention is also directed to an active-matrix FED capable of significantly improving uniformity within a pixel and a contrast ratio of the display by controlling a plurality of field emitters within the pixel on a separate basis or a group basis using a plurality of TFTs that are connected in series to each other.

### Technical Solution

One aspect of the present invention provides a FED comprising: a cathode plate including a substrate, first and second thin film transistors (TFTs) that are serially connected on the substrate, a field emitter disposed on a drain electrode of the second TFT, a gate insulating layer having a gate hole surrounding the field emitter, and field emission gate electrodes disposed on the gate insulating layer; and an anode plate including a substrate, and red, green, and blue phosphors disposed on the substrate, wherein the cathode plate and the anode plate are vacuum-packaged parallel and opposite to each other.

Source and drain electrodes of the first and second TFTs may be serially connected to each other, and gate electrodes of the first and second TFTs may be commonly or separately disposed.

The second TFT may include a high voltage transistor capable of enduring a drain voltage not less than 25 V.

Each pixel of the cathode plate may have one first TFT and a plurality of second TFTs. When each pixel has a plurality of second TFTs, each of the second TFTs may have a separate field emitter, and the field emitter may have a common or separate field emission gate electrode.

Active layers of the first and second TFTs may be formed of at least one selected from the group consisting of amorphous silicon (a-Si), microcrystalline silicon (mc-Si), polycrystalline silicon (poly-Si), a semiconductor having a wide band gap such as ZnO, and an organic semiconductor.

The field emitter may be formed of at least one carbon material selected from the group consisting of diamond, diamond like carbon, carbon nanotubes, and carbon nanofibers, and the field emitter may be directly grown by a chemical vapor deposition method (CVD) or a paste method using powder.

Physical sizes of the gate insulating layer and the gate hole surrounding the field emitter may be significantly larger and thicker than the field emitter.

The gate insulating layer having the gate hole and the field emission gate electrode may be formed on a substrate separate from the cathode plate and then combined with the cathode plate at the time of vacuum-packaging.

### ADVANTAGEOUS EFFECTS

As described above, a pixel of a FED is composed of first and second TFTs that are serially connected to each other, and a field emitter disposed on a portion of a drain electrode of the second TFT, so that intra-pixel uniformity as well as uniformity between pixels can be significantly improved, and the first and second TFTs that are serially connected to each other can have a high endurance to a high voltage to significantly enhance the lifetime of the FED. In addition, the first and second TFTs that are serially connected to each other can significantly reduce an inherent source-drain leakage current of the TFT so that a contrast ratio of the FED can be significantly enhanced.

### BRIEF DESCRIPTION OF THE DRAWINGS

FIG. 1 is a cross-sectional view of a pixel of a conventional passive-matrix FED;

FIG. 2 is a schematic diagram of a cathode plate of a conventional passive-matrix FED;

FIG. 3 is a cross-sectional view of a pixel of a conventional active-matrix FED;

FIG. 4 is a schematic diagram of a cathode plate of a conventional active-matrix FED;

FIG. 5 is a cross-sectional view of a pixel of an active-matrix FED in accordance with an exemplary embodiment of the present invention;

FIG. 6 is a schematic diagram of a cathode plate of the active-matrix FED shown in FIG. 5;

FIG. 7 is a schematic diagram of a cathode plate of an active-matrix FED in accordance with another exemplary embodiment of the present invention; and

FIG. 8 is a schematic diagram of a cathode plate of an active-matrix FED in accordance with still another exemplary embodiment of the present invention.

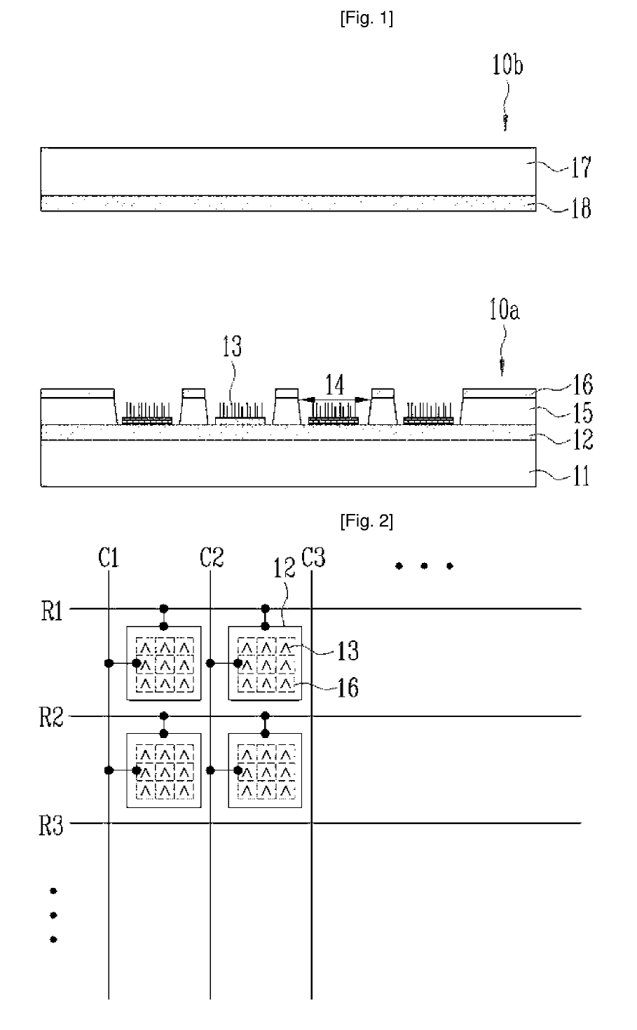

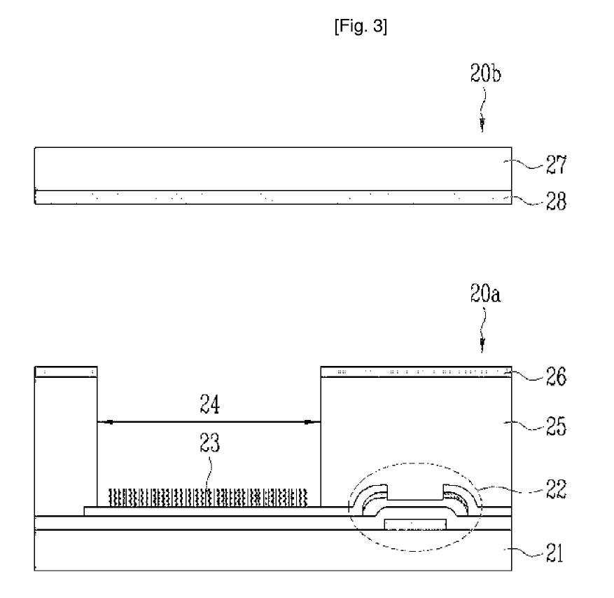

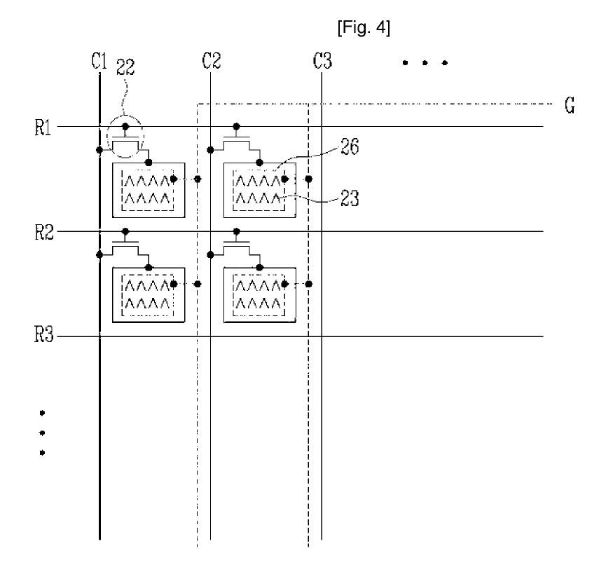

### MODE FOR THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to those skilled in the art.

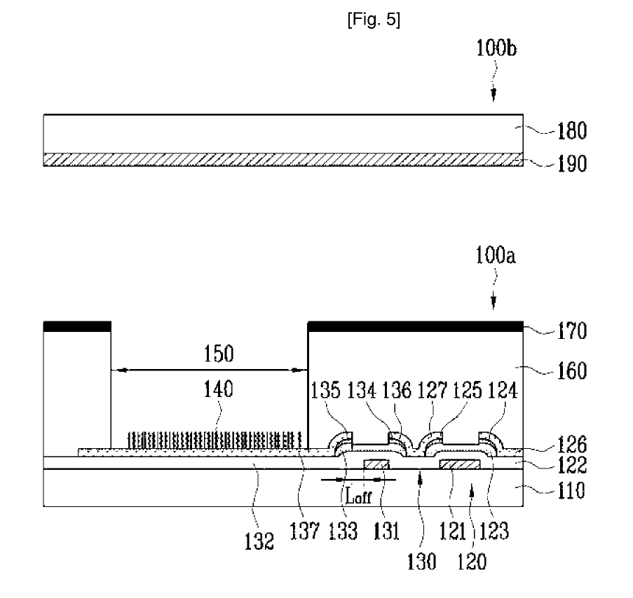

FIG. 5 is a cross-sectional view of a pixel of an active-matrix FED in accordance with an exemplary embodiment of the present invention.

As shown in FIG. 5, the FED in accordance with the present invention includes a cathode plate 100a and an anode plate 100b. The cathode plate 100a includes a glass substrate 110, a first TFT 120 (T1) and a second TFT 130 (T2) that are serially connected to each other and disposed on a portion of the glass substrate 110, a field emitter 140 disposed on a portion of a drain electrode of the second TFT 130, a gate hole 150 surrounding the field emitter 140, a gate insulating layer 160, and a field emission gate electrode 170 disposed on a portion of the gate insulating layer 160, and the anode plate 100b includes another glass substrate 180, and red, green, and blue phosphors 190 disposed on portions of the glass substrate 180. The cathode plate 100a and the anode plate 100b are vacuum-packaged parallel and opposite to each other.

The first TFT 120 is composed of a gate 121 of a TFT formed of metal or alloy on a portion of the glass substrate 110, a gate insulating layer 122 of the TFT formed of an amorphous silicon nitride (a-SiNx) layer or a silicon oxide layer on the glass substrate 110 having the gate 121, an active layer 123 of the TFT formed of amorphous silicon (a-Si) on a portion of the gate insulating layer 122 and the gate 121, a source 124 and a drain 125 of the TFT that are formed of n-type amorphous silicon at both sides of the active layer 123, a source electrode 126 of the TFT formed of metal or alloy on a portion of the gate insulating layer 122 and the source 124, and a drain electrode 127 of the TFT formed of metal or alloy on a portion of the gate insulating layer 122 and the drain 125.

The second TFT 130 is composed of a gate 131 of a TFT formed of metal or alloy on a portion of the glass substrate 110, a gate insulating layer 132 of the TFT formed of an amorphous silicon nitride (a-SiNx) layer or a silicon oxide layer on the glass substrate 110 having the gate 131, an active layer 133 of the TFT formed of amorphous silicon (a-Si) on a portion of the gate insulating layer 132 and the gate 131, a source 134 and a drain 135 of the TFT that are formed of n-type amorphous silicon at both sides of the active layer 133, a source electrode 136 of the TFT formed of metal or alloy on a portion of the gate insulating layer 132 and the source 134, and a drain electrode 137 of the TFT formed of metal or alloy on a portion of the gate insulating layer 132 and the drain 135.

The gate insulating layer 122 of the first TFT 120 and the gate insulating layer 132 of the second TFT 130 are formed of the same material, the drain electrode 127 of the first TFT 120 and the source electrode 136 of the second TFT 130 are formed of the same material and are continuously connected to each other, and the gate electrodes 121 and 131 of the respective first and second TFTs 120 and 130 are connected to each other or are separately disposed.

The second TFT 130 is composed of a high voltage TFT, which has an offset length L_{off} that does not allow its gate 131 and drain 135 to vertically overlap each other, so that it can endure a drain voltage not less than 25 V.

The field emitter 140 is composed of a layer formed of diamond, diamond like carbon, carbon nanotubes, carbon nanofibers, or the like, for example, a thin layer or thick layer, and may be formed by a direct growth method such as a chemical vapor deposition method, or a paste method using powder.

Physical sizes of the gate insulating layer 160 and the gate hole 150 may be larger and thicker than the field emitter 140, for example, not less than one time but not more than one hundred times the field emitter 140. In addition, the field emission gate electrode 170 and the gate insulating layer 160 having the gate hole 150 may be formed on a plate separate from the cathode plate 110a and then combined with the cathode plate 110a at the time of vacuum-packaging.

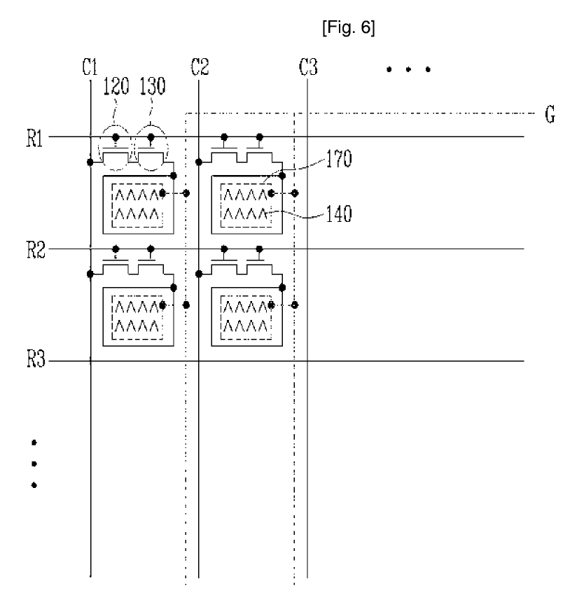

FIG. 6 is a schematic diagram of a cathode plate of the active-matrix FED shown in FIG. 5.

As shown in FIG. 6, the gate electrodes of the first and second TFTs are connected to row buses R1, R2, R3, . . . , the source electrodes of the first TFTs are connected to column buses C1, C2, C3, . . . , and the field emission gate electrodes 170 of the field emitters of respective pixels are connected to the line G in common.

The FED of the present embodiment may be driven by the following method. Scan and data signals for driving the FED are addressed to the gate electrodes of the first TFT 120 and/or second TFT 130, and the source electrode of the first TFT 120, respectively, and a voltage is applied to the field emission gate electrode 170 to induce electrons to be emitted from the field emitter 140 while a high voltage is applied to the anode plate to accelerate the emitted electrons with high energy to represent an image. In this case, the gray representation of the display is obtained by changing a pulse width or a pulse amplitude of the data signal. For reference, the scan and data signals of the FED may be addressed to the gate electrodes of the first TFT 120 and/or second TFT 130, and the source electrode of the first TFT 120, respectively.

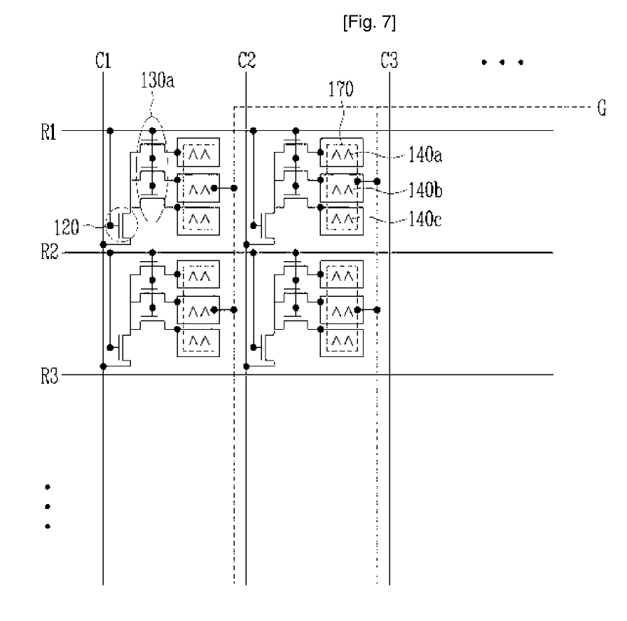

FIG. 7 is a schematic diagram of a cathode plate of an active-matrix FED in accordance with another exemplary embodiment of the present invention.

FIG. 7 differs from the embodiment of FIG. 6 in that each pixel is composed of a first TFT 120 and a plurality of second TFTs 130a, and source electrodes of the second TFTs 130a are serially connected to the drain electrode of the first TFT 120. In addition, it differs from the embodiment of FIG. 6 in that separate field emitters 140a, 140b, and 140c are connected to the respective drain electrodes 137 of the second TFTs 130a and disposed to correspond to the field emission gate electrode 170 in common.

According to the above-described configuration, the second TFTs 130a serially connected to the first TFT 120 can significantly improve the intra- and inter-pixel uniformity.

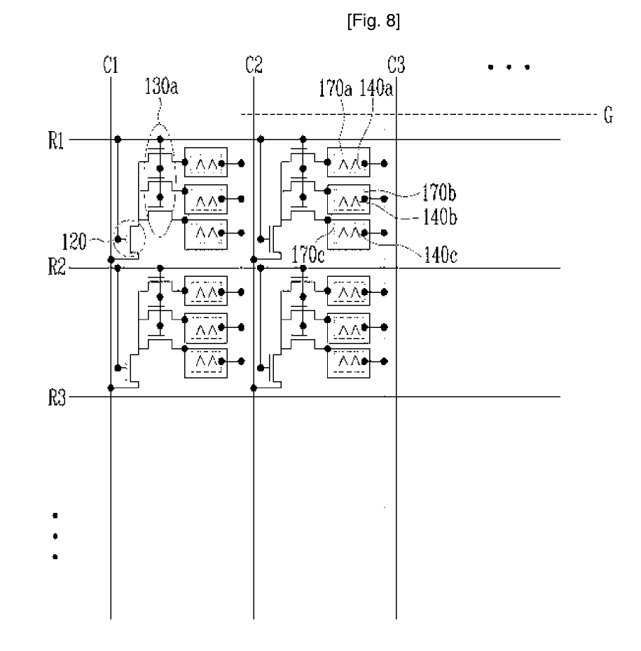

FIG. 8 is a schematic diagram of a cathode plate of an active-matrix FED in accordance with still another exemplary embodiment of the present invention.

FIG. 8 differs from the embodiment of FIG. 7 in that a plurality of field emission gate electrodes 170a, 170b, and 170c are independently disposed from each other while corresponding to field emitters 140a, 140b, and 140c connected to the respective drain electrodes of the second TFTs 130a.

According to the above-described configuration, the field emitters can be controlled on an independent basis or a group basis to significantly improve the intra- and inter-pixel uniformity.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

1. A field emission display (FED), comprising:
a cathode plate including a substrate, first and second thin film transistors (TFTs) that are serially connected on the substrate, a field emitter disposed on a drain electrode of the second TFT, a gate insulating layer having a gate hole surrounding the field emitter, and field emission gate electrodes disposed on the gate insulating layer; and
an anode plate including a substrate, and red, green, and blue phosphors disposed on the substrate,
wherein the cathode plate and the anode plate are vacuum-packaged parallel and opposite to each other.

2. The FED according to claim 1, wherein source and drain electrodes of the first and second TFTs are serially connected to each other, and gate electrodes of the first and second TFTs are commonly or separately disposed.

3. The FED according to claim 1, wherein the second TFT comprises a high voltage transistor capable of enduring a drain voltage not less than 25 V.

4. The FED according to claim 3, wherein the second TFT has an offset length that does not allow the gate and the drain of the second TFT to vertically overlap each other.

5. The FED according to claim 1, wherein active layers of the first and second TFTs are formed of at least one selected from the group consisting of amorphous silicon (a-Si), microcrystalline silicon (mc-Si), polycrystalline silicon (poly-Si), a semiconductor having a wide band gap such as ZnO, and an organic semiconductor.

6. The FED according to claim 1, wherein each pixel of the cathode plate comprises one first TFT and a plurality of second TFTs.

7. The FED according to claim 6, wherein each of the second TFTs is connected to a separate field emitter.

8. The FED according to claim 7, wherein each of the field emitters connected to the respective second TFTs corresponds to the common or separate field emission gate electrode.

9. The FED according to claim 1, wherein the field emitter is formed of at least one carbon material selected from the group consisting of diamond, diamond like carbon, carbon nanotubes, and carbon nanofibers.

10. The FED according to claim 9, wherein the carbon field emitter is directly grown by a chemical vapor deposition method or a paste method using powder.

11. The FED according to claim 1, wherein the gate insulating layer has a thickness of not less than one time but not more than one hundred times the thickness of the field emitter.

12. The FED according to claim 1, wherein the field emission gate electrode and the gate insulating layer having the gate hole are fabricated on a substrate separate from the cathode plate and then vacuum-packaged with the cathode plate and the anode plate.

13. The FED according to claim 1, wherein scan and data signals for driving the display are addressed to gate electrodes of the first TFT 120 and/or second TFT 130, and source electrode of the first TFT 120, respectively, and a voltage is applied to the field emission gate electrode to induce electrons to be emitted from the field emitter while a high voltage is applied to the anode plate to accelerate the emitted electrons with high energy, so that an image is represented.

14. The FED according to claim 13, wherein gray representation of the display is obtained by changing a pulse width or a pulse amplitude of the data signal.
